(19) United States
(12) Patent Application Publication
(10) Pub. No.: US 2011/0222445 A1
(43) Pub. Date: Sep. 15, 2011

(54) ENHANCEMENT OF USER EQUIPMENT RECEIVER SENSITIVITY

(75) Inventor: Seppo Alanara, Oulu (FI)

(73) Assignee: NOKIA CORPORATION, Espoo (FI)

(21) Appl. No.: 13/130,297

(22) PCT Filed: Dec. 30, 2008
(86) PCT No.: PCT/IB2008/055590

§ 371 Date: May 19, 2011

(51) Int. Cl. H04J 1/00

(52) U.S. Cl. 370/281

(57) ABSTRACT

The exemplary embodiments of the invention provide in one aspect thereof an apparatus that includes a controller configurable with a radio frequency receiver. The controller is further configurable to monitor downlink signal quality of a user equipment. The controller is further configurable to compare the downlink signal quality to a threshold value and, if the downlink signal quality is less that the threshold value, to switch operation of the user equipment from a full duplex frequency division duplex mode of operation to a half duplex frequency division duplex mode of operation. The exemplary embodiments may be realized at one or both of the user equipment or a base station. The result of switching operation of the user equipment results in an increase in user equipment receiver sensitivity.

### TECHNICAL FIELD

The exemplary and non-limiting embodiments of this invention relate generally to wireless communication systems, methods, devices and computer programs and, more specifically, relate to radio frequency (RF) receivers.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
CSG closed subscriber group
DL downlink (eNB towards UE)
eNB EUTRAN Node B (evolved Node B, a base station)
EPC evolved packet core
EUTRAN evolved UTRAN (LTE)
CQI channel quality indicator
FDD frequency division duplex
FDMA frequency division multiple access
HD half duplex
LTE long term evolution
MAC medium access control
MM/MME mobility management/mobility management entity
OFDMA orthogonal frequency division multiple access
O&M operations and maintenance
PDCP packet data convergence protocol
PHY physical
RB radio bearer
RLC radio link control
RRC radio resource control
SAE system architecture evolution
SGW serving gateway

SC-FDMA single carrier, frequency division multiple access
TDD time division duplex
UE user equipment
UL uplink (UE towards eNB)
UTRAN universal terrestrial radio access network
WCDMA wideband code division multiple access

The specification of a communication system known as evolved UTRAN (EUTRAN, also referred to as UTRAN-LTE or as EUTRA) is currently nearing completion within the 3GPP. As specified the DL access technique is OFDMA, and the UL access technique is SC-FDMA.

One specification of interest is 3GPP TS 36.300, V8.6.0 (2008-09), 3rd Generation Partnership Project; Technical Specification Group Radio Access Network; Evolved Universal Terrestrial Radio Access (EUTRA) and Evolved Universal Terrestrial Access Network (EUTRAN); Overall description; Stage 2 (Release 8), incorporated by reference herein in its entirety.

FIG. 1A reproduces FIG. 4.1 of 3GPP TS 36.300, and shows the overall architecture of the EUTRAN system. The EUTRAN system includes eNBs, providing the EUTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many to many relationship between MMEs/Serving Gateways and eNBs.

The eNB hosts the following functions:
functions for Radio Resource Management: Radio Bearer Control, Radio Admission Control, Connection Mobility Control, dynamic allocation of resources to UEs in both uplink and downlink (scheduling);
IP header compression and encryption of the user data stream;
selection of a MME at UE attachment;
routing of User Plane data towards the Serving Gateway;
scheduling and transmission of paging messages (originated from the MME);
scheduling and transmission of broadcast information (originated from the MME or O&M); and
measurement and measurement report configurations for mobility and scheduling.

Another specification of interest is 3GPP TS 36.101, V8.3.0 (2008-09), 3rd Generation Partnership Project; Technical Specification Group Radio Access Network; Evolved Universal Terrestrial Radio Access (EUTRA); User Equipment (UE) radio transmission and reception (Release 8), incorporated by reference herein in its entirety.

An E-UTRA FDD capable UE, as in general does any full duplex-capable UE, includes a duplexer in the RF block. The duplexer is essentially a radio frequency filter that enables the UE to simultaneously transmit and receive in different frequency bands using the same antenna. Duplexers are not, however, perfect, and harmonics of the transmitted frequencies of the UL may superimpose on the DL received signal, thereby reducing the receiver sensitivity. The same UE, operating in the TDD mode, does not experience this problem as the transmission and the reception are separated in time.

### SUMMARY

The foregoing and other problems are overcome, and other advantages are realized, by the use of the exemplary embodiments of this invention.

In a first aspect thereof the exemplary embodiments of this invention provide a method that comprises monitoring downlink signal quality of a user equipment with a base station at least in part on measurement results received from the user equipment, and if the downlink signal quality is less than a threshold value, sending a revised radio resource allocation to the user equipment to initiate switching operation of the user equipment from a full duplex frequency division duplex mode of operation to a half duplex frequency division duplex mode of operation.

In another aspect thereof the exemplary embodiments of this invention provide a computer-readable memory medium that stores a program of computer executable instructions. Execution of the instructions results in operations that comprise monitoring downlink signal quality of a user equipment with a base station at least in part on measurement results received from the user equipment, and if the downlink signal quality is less than a threshold value, sending a revised radio resource allocation to the user equipment to initiate switching operation of the user equipment from a full duplex frequency division duplex mode of operation to a half duplex frequency division duplex mode of operation.

In a further aspect thereof the exemplary embodiments of this invention provide an apparatus that comprises a controller configurable with a radio frequency receiver and further configurable to monitor downlink signal quality of a user equipment at least in part on measurement results received from the user equipment. The controller is further configurable to compare the downlink signal quality to a threshold value and, if the downlink signal quality is less than the threshold value, to switch operation of the user equipment from a full duplex frequency division duplex mode of operation to a half duplex frequency division duplex mode of operation.

In a still further aspect thereof the exemplary embodiments of this invention provide an apparatus that comprises a controller configurable with a radio frequency receiver and a radio frequency transmitter and further configurable to monitor downlink signal quality of a user equipment. The controller is further configurable to compare the downlink signal quality to a threshold value and, if the downlink signal quality is less than the threshold value, to send a request to a base station to switch operation of the user equipment from a full duplex frequency division duplex mode of operation to a half duplex frequency division duplex mode of operation, where switching is performed at least partially in response to receiving a revised radio resource allocation from the base station, and where the request is sent at least partially in response to detecting that the base station is scheduling uplink and downlink resources such that transmission coincides with reception.

### BRIEF DESCRIPTION OF THE DRAWINGS

In the attached Drawing Figures:

FIG. 1A reproduces FIG. 4.1 of 3GPP TS 36.300, and shows the overall architecture of the EUTRAN system.

FIG. 1B reproduces FIG. 4.1-1 of 3GPP TS 36.211, and shows an EUTRAN frame structure type 1.

FIG. 2A shows a simplified block diagram of various electronic devices that are suitable for use in practicing the exemplary embodiments of this invention.

FIG. 2B shows a more particularized block diagram of user equipment such as that shown at FIG. 2A.

FIG. 3 is a logic flow diagram that illustrates the operation of a method, and a result of execution of computer program instructions embodied on a computer readable memory, in accordance with the exemplary embodiments of this invention.

### DETAILED DESCRIPTION

The exemplary embodiments of this invention that are described below may be used to advantage in the SAE/LTE E-UTRAN type of wireless communication system. This particular system may sometimes be referred to as a 3.9G Radio Access Technology, and is currently planned to replace and upgrade the 3G WCDMA UTRAN radio access network. However, the exemplary embodiments of this invention are not to be construed as being limited for use only with this particular radio access network, as they are also applicable for use in other current and future types of radio access networks.

As is presently specified in EUTRAN, the TDD mode is possible to emulate in the FDD mode. This operating mode is referred to as half duplex FDD. All UEs that can operate in the full duplex FDD mode (“regular” FDD) are capable of half duplex FDD operation mode if the eNB supports half duplex FDD and controls and schedules the UE so that UE transmission does not coincide with UE reception. The purpose of providing half duplex FDD in the LTE specifications is due at least in part to operator requests to enable UEs without a duplexer to operate in an FDD frequency band.

That is, the FDD mode of LTE can be operated in either the full duplex mode or the half duplex mode. Half duplex FDD, in which the UE separates transmission and reception in frequency and time, is useful because it allows the UE to operate with relaxed duplex filter requirements. This, in turn, reduces the cost of terminals and makes it possible to exploit FDD frequency bands that could not otherwise be used (e.g., too narrow duplex distance).

Reference can be made, for example, to 3GPP TS 36.211, V8.4.0 (2008-09), 3rd Generation Partnership Project; Technical Specification Group Radio Access Network; Evolved Universal Terrestrial Radio Access (EUTRA); Physical channels and modulation (Release 8), incorporated by reference herein in its entirety.

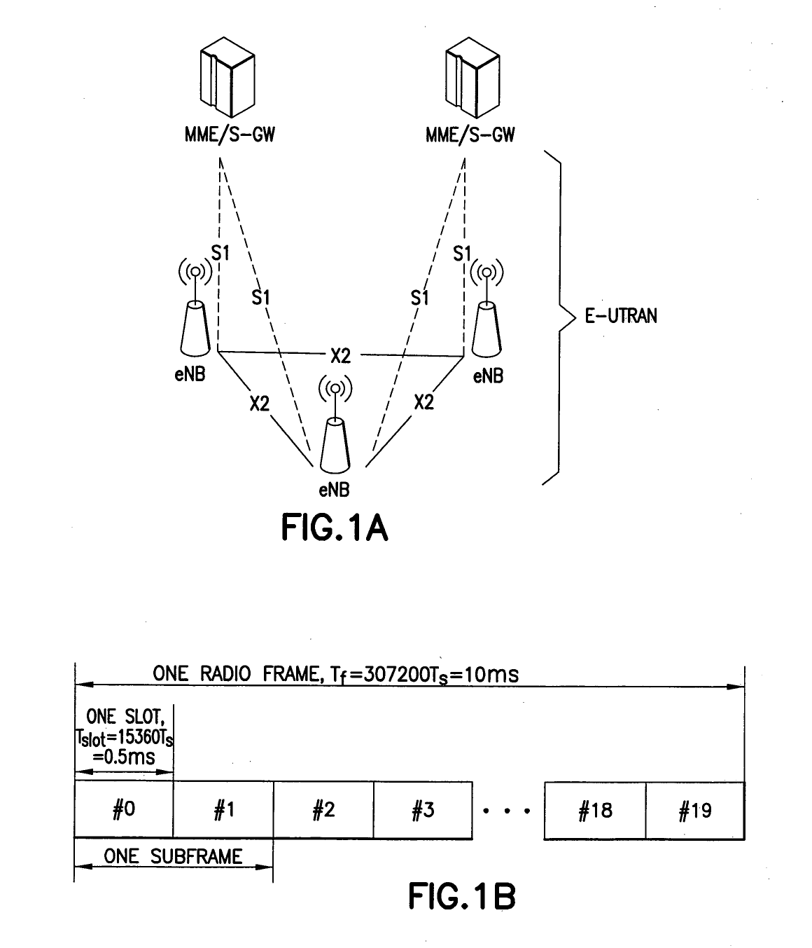

Section 4.1 of 3GPP TS 36.211 describes the frame structure type 1. Reference in this regard can also be made to FIG. 1B, which reproduces FIG. 4.1-1 of 3GPP TS 36.211. The frame structure type 1 is applicable to both full duplex and half duplex FDD. Each radio frame is T_{f}=307200·Tₛ=10 ms long and consists of 20 slots of length Tₛₗₒₜ=15360·Tₛ=0.5 ms , numbered from 0 to 19. A subframe is defined as two consecutive slots where subframe i consists of slots 2i and 2i+1.

For FDD, 10 subframes are available for downlink transmission and 10 subframes are available for uplink transmissions in each 10 ms interval. Uplink and downlink transmissions are separated in the frequency domain. In half-duplex FDD operation, the UE cannot transmit and receive at the same time, while there are no such restrictions in full-duplex FDD.

As aspect of the exemplary embodiments of this invention exploits the fact that if it is assumed that the eNB has the capability to operate in the half duplex FDD mode, then it may set a FDD UE into the half duplex FDD mode for the purpose of improving the UE receiver sensitivity. This can be very beneficial for a UE operating at or near the cell border. One result is an improvement in the cell range. The improvement in receiver sensitivity may be about 1 dB, as a non-limiting example. The exemplary embodiments of this invention may also be useful when the UE is operating with CSG cells, and in other situations as well.

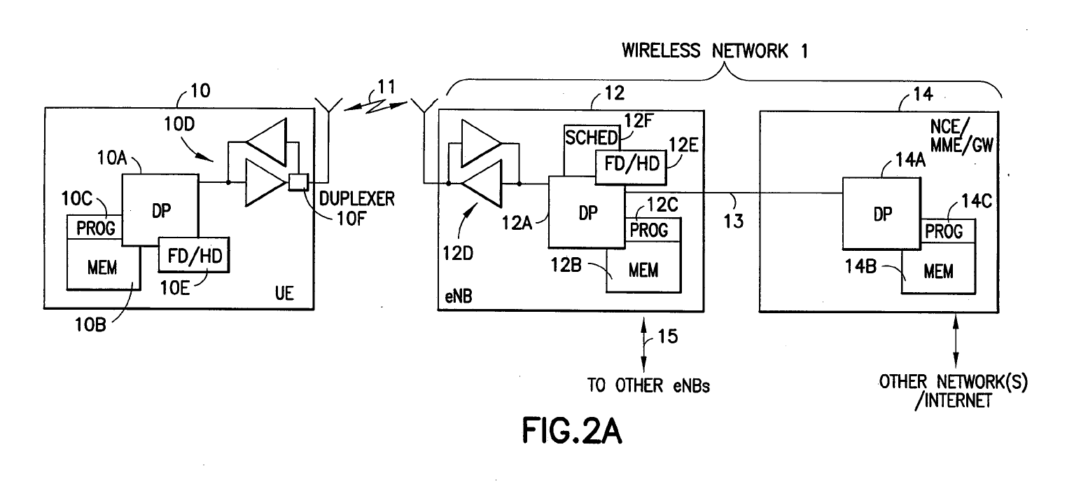

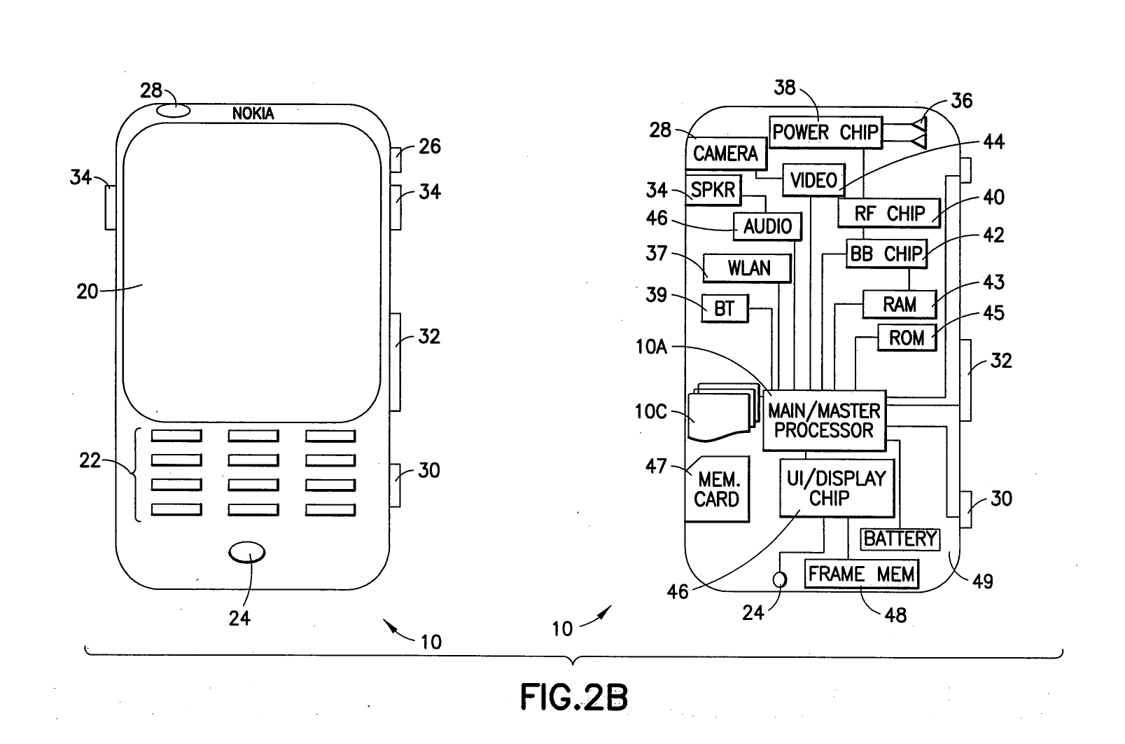

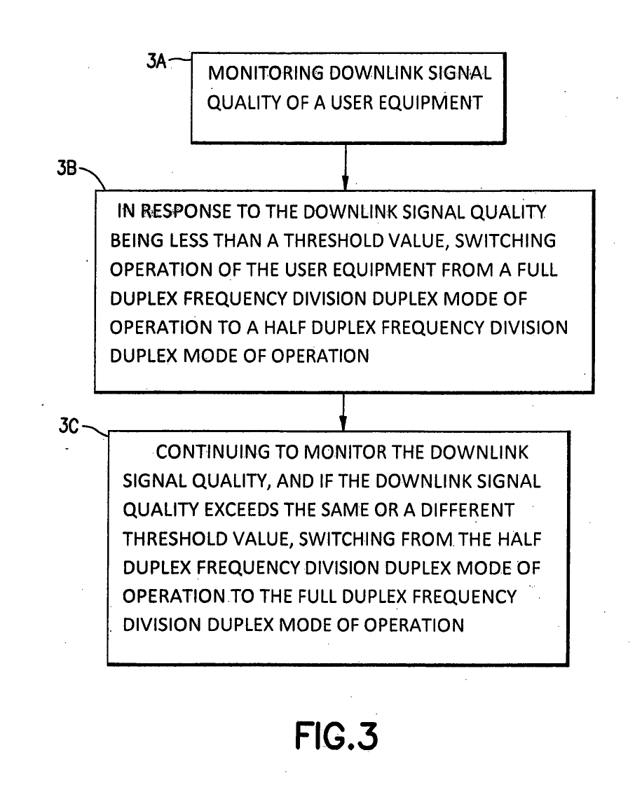

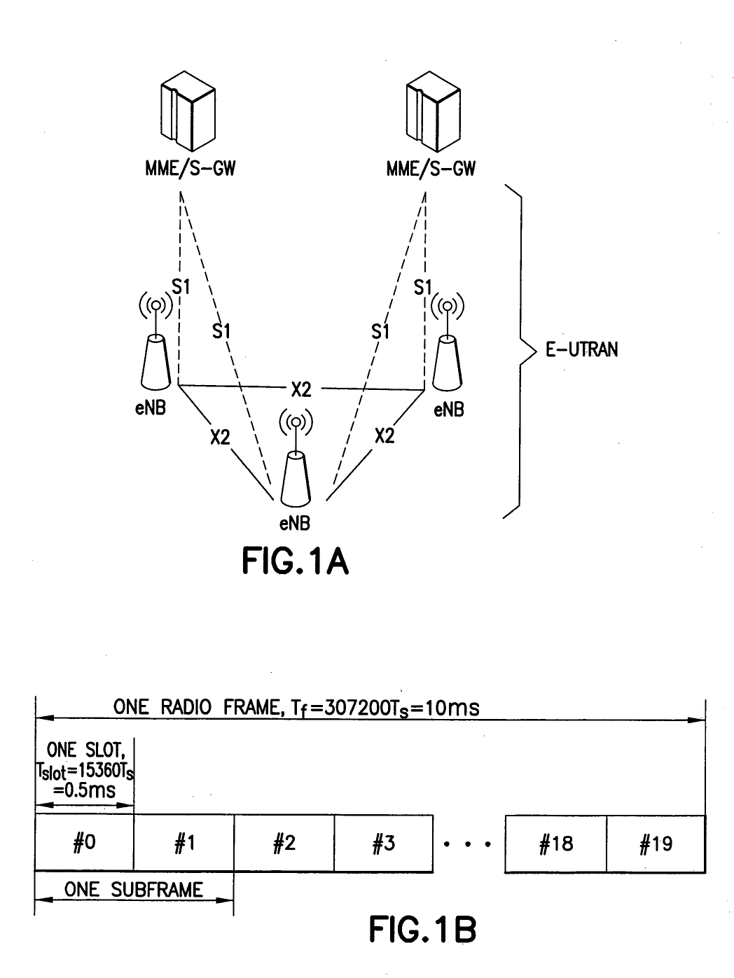

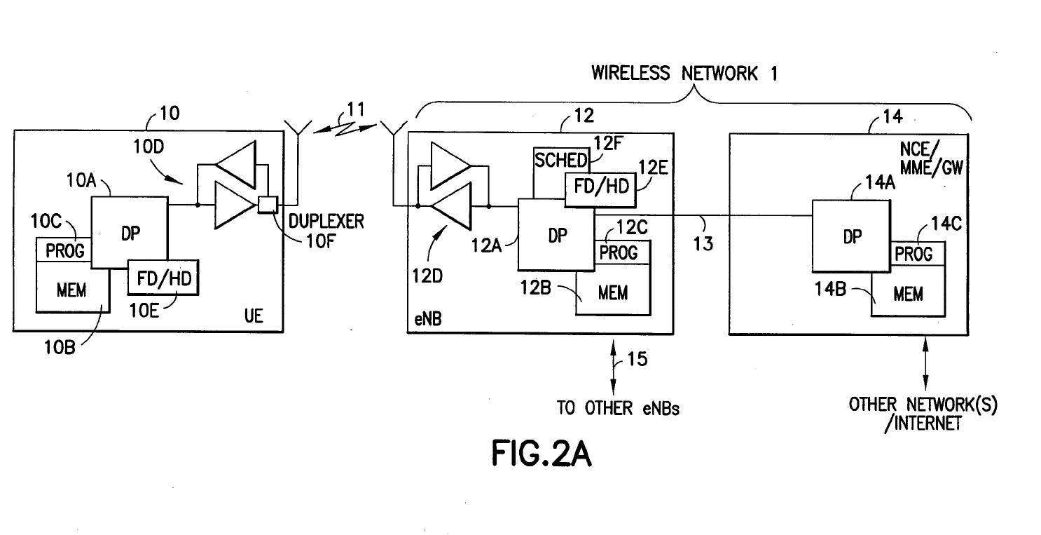

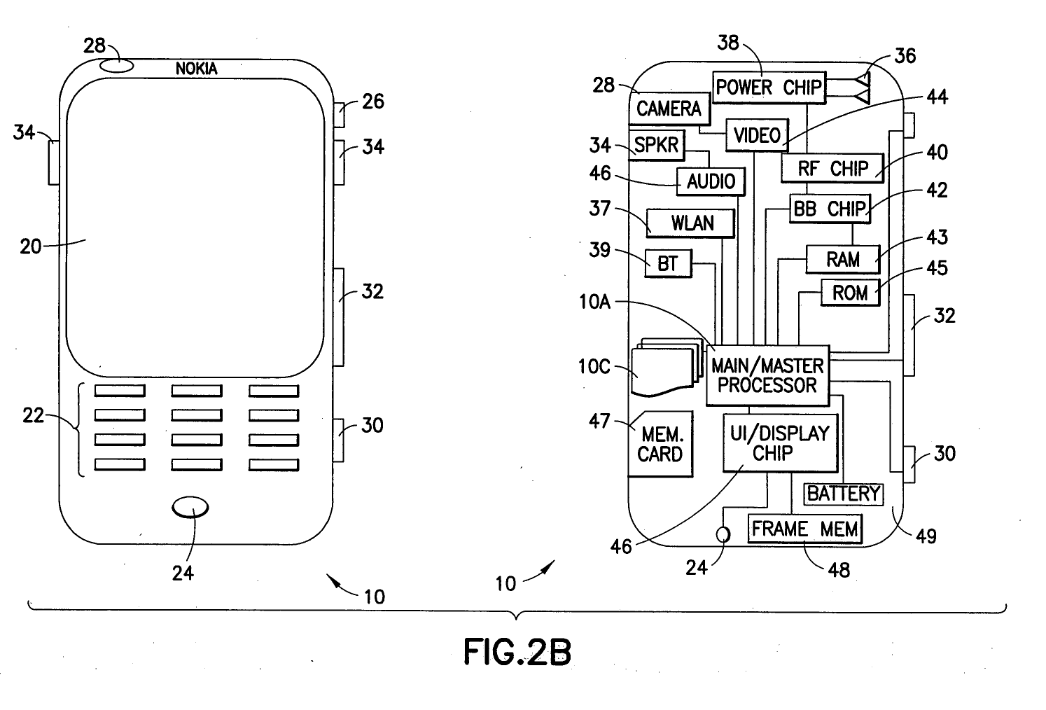

Before describing in further detail the exemplary embodiments of this invention, reference is made to FIG. 2A for illustrating a simplified block diagram of various electronic devices and apparatus that are suitable for use in practicing the exemplary embodiments of this invention. In FIG. 2A a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1A, and which provides connectivity with a further network, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1 A.

At least one of the PROGs 10C and 12C is assumed to include program instructions that, when executed by the associated DP, enable the device to operate in accordance with the exemplary embodiments of this invention, as will be discussed below in greater detail.

That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include a full duplex/half duplex (FD/HD) operation unit 10E, and the eNB 12 may also include a corresponding FD/HD operation unit 12E. The UE 10 may also include a duplexer 10F, which may be embodied using any type of suitable duplexer/filter technology. The eNB 12 also includes a resource scheduling unit (SCHED) 12F.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on multicore processor architectures, as non-limiting examples.

FIG. 2B illustrates further detail of an exemplary UE 10 in both plan view (left) and sectional view (right), and the invention may be embodied in one or some combination of those more function-specific components. At FIG. 2B the UE 10 has a graphical display interface 20 and a user interface 22 illustrated as a keypad but understood as also encompassing touch screen technology at the graphical display interface 20 and voice recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 30 which may alternatively function as a volume adjustment for the speaker(s) 34 when the camera 28 is not in an active mode.

Within the sectional view of FIG. 2B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio frequency (RF) chip 40 which demodulates and downconverts the signal for baseband processing. The baseband (BB) chip 42 detects the signal which is then converted to a bit stream and finally decoded. Similar processing occurs in reverse for signals generated in the apparatus 10 and transmitted from it.

Those signals going to and from the camera 28 pass through an image/video processor 44. This unit operates to encode and decode various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on the chip or be coupled to an antenna off the chip. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The processors 38, 40, 42, 44, 46, 50, if embodied as separate entities in a UE 10 or eNB 12, may operate in a slave relationship to the main processor 10A, 12A, which may then be in a master relationship to them. Embodiments of this invention may be disposed across various chips and memories as shown, or disposed within another processor that combines some of the functions described above for FIG. 2B. Any or all of these various processors of FIG. 2B access one or more of the various memories, which may be on chip with the processor or separate from the processor. Similar function-specific components that are directed toward communications over a network broader than a piconet (e.g., components 36, 38, 40, 42-45 and 47) may also be disposed in exemplary embodiments of the access node 12, which may have an array of tower mounted antennas rather than the two shown at FIG. 2B.

Note that the various integrated circuits (e.g., chips 38, 40, 42, etc.) that were described above may be combined into a fewer number than described and, in a most compact case, may all be embodied physically within a single chip.

The eNB 12 of FIG. 2A is assumed to control the UE 10 measurements and measurement reports, and is thus capable of monitoring UE 10 receiver quality. This can be based at least in part of CQI measurement results received from the UE 10. Based on the monitoring and evaluation, which may be performed at least in part by the FD/HD operation unit 12E, the eNB 12 is enabled in one exemplary embodiment of this invention to determine if a mode change from full duplex FDD to half duplex FDD would improve the UE 10 receiver sensitivity, and would thus facilitate UE 10 operation in a case where there is considerable interference present in the UE 10 receiver. If the UE 10 receiver quality drops below some fixed or variable lower limit value (a threshold value), or if the eNB 12 confirms by some other means that the UE 10 can benefit from half duplex FDD operation, the eNB 12 scheduler 12F changes the allocations for active radio bearers so that the UE 10 is effectively placed into the half duplex FDD mode. In the half duplex FDD mode the UE 10 UL transmissions are separated in time from the UE 10 DL receptions and, as a result, the UE 10 transmitter does not cause interference in the UE 10 receiver.

Further in accordance with the exemplary embodiments of this invention the UE 10 may monitor its own received signal quality, and if the received signal quality falls below some threshold value, the UE 10 may request that it be shifted into the half duplex FDD mode to enhance its receiver quality and sensitivity. Note in this regard that the UE 10 is able to detect when the eNB 12 is scheduling UL and DL resources so that transmission coincides with reception, and it may use this information to expedite the request for the half duplex service mode.

Further in this regard, both the UE 10 and the eNB 12 are able to detect when the eNB scheduler 12F has assigned the shared channel resources so that reception and transmission coincide. This may then be used as a further condition of when the resource scheduling in the eNB 12 is effectively changed into the half duplex type. Note that this is not a mandatory condition, although a UE 10 experiencing bad radio conditions may be set into the half duplex service mode also as a precaution to prevent the scheduler 12F from applying the simultaneous UL and DL at a later time when the poor radio conditions are still present. In some cases it may be difficult for the scheduler 12F to fully honor the UE request, but awareness of the radio path conditions of the UE 10 will ensure that the eNB scheduler 12F considers the best compromise of the available resources for the UE 10.

The ability of the UE 10 monitor its radio conditions and request to be shifted to the half duplex mode may be useful in a case where, for example, the use of the eNB 12 controlled measurements would result in too long a time elapsing after the receiver quality degrades before the eNB 12 commands the UE 10 to shift to the half duplex FDD mode. The UE 10 is thus enabled to sustain the quality of existing signaling and data radio bearers so that a current connection is not dropped. The request may be implemented, as non-limiting examples, by a newly provided element in UE 10 RRC signaling or MAC messages, or possibly through a capability indication where the UE 10 indicates to the eNB 12 that it supports FDD operation only in the half duplex FDD mode. This UE 10 capability to request that it be placed in the half duplex FDD mode may be embodied at least partially in the FD/HD operation unit 10E.

Note that the UE 10 receiver quality may be found to be degraded when it is operating at or near the cell edge. However, the UE 10 receiver quality may also suffer as a result of other conditions, such as when it is operating in a deep fade condition.

As such, the system is preferably implemented to continue monitoring the UE 10 receiver quality, and if it improves to perform another mode change from the half duplex FDD mode to the full duplex FDD mode. This may involve the use of the same or a different threshold value. Note, however, that it is preferred to provide some threshold hysteresis so as to prevent the UE 10 ping-ponging between the half and full duplex FDD modes when it is in a borderline area. Switching back to the full duplex FDD mode when possible may be generally desirable to at least increase throughput.

The use of these exemplary embodiments may improve the UE 10 receiver sensitivity by, for example, approximately at least 1 dB. Note, however, that the actual gain in receiver sensitivity that is achieved may be a function of a number of factors including, but not limited to, one or more of the separation between the transmit and receive frequencies, the quality and separation of the duplexer passband filters for the transmit and the receive signal paths, the quality of the transmitter power amplifier, and the actual transmit power that is in use.

Based on the foregoing it should be apparent that the exemplary embodiments of this invention provide a method, apparatus and computer program(s) to operate a user equipment in a radio access network with a base station, such as an eNB.

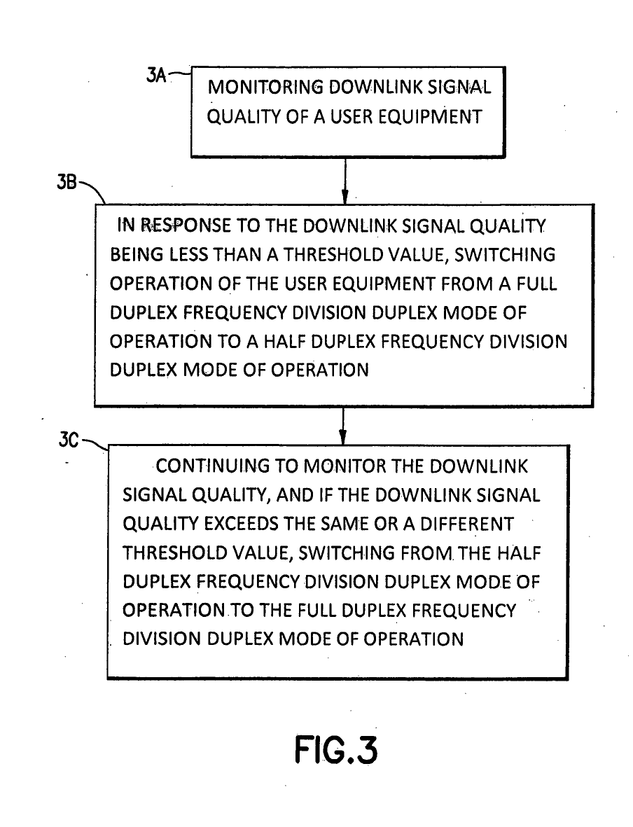

FIG. 3 is a logic flow diagram that illustrates the operation of a method, and a result of execution of computer program instructions, in accordance with the exemplary embodiments of this invention. In accordance with these exemplary embodiments a method performs, at Block 3A, a step of monitoring downlink signal quality of a user equipment. At Block 3B there is a step of, in response to the downlink signal quality being less than a threshold value, switching operation of the user equipment from a full duplex frequency division duplex mode of operation to a half duplex frequency division duplex mode of operation.

In the method, and as the result of execution of the computer program instructions, where monitoring is performed by a base station at least in part on measurement results received from the user equipment, and where switching is performed in response to the base station sending a command to the user equipment.

In the method, and as the result of execution of the computer program instructions, where monitoring is performed by the user equipment, further comprising sending a request to a base station to switch operation from the full duplex frequency division duplex mode of operation to the half duplex frequency division duplex mode of operation, and where switching is performed at least partially in response to receiving a revised radio resource allocation from the base station.

In the method, and as the result of execution of the computer program instructions, where the downlink operates in accordance with an orthogonal frequency division multiple access technique.

In the method, and as the result of execution of the computer program instructions, further comprising (Block 3C of FIG. 3) continuing to monitor the downlink signal quality, and if the downlink signal quality exceeds the same or a different threshold value, switching from the half duplex frequency division duplex mode of operation to the full duplex frequency division duplex mode of operation.

In the method, and as the result of execution of the computer program instructions, where switching results in an increase in user equipment receiver sensitivity.

The various blocks shown in FIG. 3 may be viewed as method steps, and/or as operations that result from operation of computer program code, and/or as a plurality of coupled logic circuit elements constructed to carry out the associated function(s).

Also disclosed herein is an apparatus that includes a controller configurable with a radio frequency receiver, and that is further configurable to monitor downlink signal quality of a user equipment. The controller further configurable to compare the downlink signal quality to a threshold value and, if the downlink signal quality is less than the threshold value, to switch operation of the user equipment from a full duplex frequency division duplex mode of operation to a half duplex frequency division duplex mode of operation.

In one non-limiting embodiment the controller and the radio frequency receiver are embodied at a base station, and the controller monitors at least in part measurement results received from the user equipment. The controller is further configurable with a radio frequency transmitter to transmit at least a revised radio resource allocation to the user equipment to cause the user equipment to switch from the full duplex frequency division duplex mode of operation to the half duplex frequency division duplex mode of operation.

In another non-limiting embodiment the controller and the radio frequency receiver are embodied at the user equipment, and the controller is further configurable with a radio frequency transmitter to transmit a request to a base station to switch operation from the full duplex frequency division duplex mode of operation to the half duplex frequency division duplex mode of operation. In this embodiment switching is performed at least partially in response to receiving a revised radio resource allocation from the base station.

In an exemplary embodiment the downlink operates in accordance with an orthogonal frequency division multiple access technique.

The controller may be configurable to continue to monitor the downlink signal quality, and if the downlink signal quality exceeds the same or a different threshold value, to cause the user equipment to switch from the half duplex frequency division duplex mode of operation to the full duplex frequency division duplex mode of operation.

The exemplary embodiments of this invention also provide an apparatus that comprises means for monitoring downlink signal quality of a user equipment, and means, responsive to the downlink signal quality being less than a threshold value, for switching operation of the user equipment from a full duplex frequency division duplex mode of operation to a half duplex frequency division duplex mode of operation.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the EUTRAN (UTRAN-LTE) system, and further revisions and releases thereof, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-19. (canceled)

20. A method, comprising:
monitoring downlink signal quality of a user equipment with a base station at least in part on measurement results received from the user equipment; and
if the downlink signal quality is less than a threshold value, sending a revised radio resource allocation to the user equipment to initiate switching operation of the user equipment from a full duplex frequency division duplex mode of operation to a half duplex frequency division duplex mode of operation.

21. The method of claim 20, where monitoring is also performed by the user equipment, further comprising sending a request to a base station to switch operation from the full duplex frequency division duplex mode of operation to the half duplex frequency division duplex mode of operation, and where switching is performed at least partially in response to receiving a revised radio resource allocation from the base station.

22. The method of claim 20, where the downlink operates in accordance with an orthogonal frequency division multiple access technique.

23. The method of claim 20, further comprising continuing to monitor the downlink signal quality, and if the downlink signal quality exceeds the same or a different threshold value, switching from the half duplex frequency division duplex mode of operation to the full duplex frequency division duplex mode of operation.

24. The method of claim 21, where the request is sent at least partially in response to the user equipment detecting that the base station is scheduling uplink and downlink resources such that transmission coincides with reception.

25. The method of claim 20, where switching results in an increase in user equipment receiver sensitivity.

26. A computer-readable memory medium that stores a program of computer executable instructions, where execution of the instructions results in operations that comprise:
monitoring downlink signal quality of a user equipment with a base station at least in part on measurement results received from the user equipment; and
if the downlink signal quality is less than a threshold value, sending a revised radio resource allocation to the user equipment to initiate switching operation of the user equipment from a full duplex frequency division duplex mode of operation to a half duplex frequency division duplex mode of operation.

27. The memory medium of claim 26, where the memory medium is embodied at the user equipment and where the operation of monitoring is also performed by the user equipment, further comprising an operation of sending a request to a base station to switch operation from the full duplex frequency division duplex mode of operation to the half duplex frequency division duplex mode of operation, and where switching is performed at least partially in response to receiving a revised radio resource allocation from the base station.

28. The memory medium of claim 26, where the downlink operates in accordance with an orthogonal frequency division multiple access technique.

29. The memory medium of claim 26, further comprising operations of continuing to monitor the downlink signal quality, and if the downlink signal quality exceeds the same or a different threshold value, switching from the half duplex frequency division duplex mode of operation to the full duplex frequency division duplex mode of operation.

30. The memory medium of claim 27, where the request is sent at least partially in response to the user equipment detecting that the base station is scheduling uplink and downlink resources such that transmission coincides with reception.

31. The memory medium of claim 26, where switching results in an increase in user equipment receiver sensitivity.

32. An apparatus, comprising:
a controller configurable with a radio frequency receiver and further configurable to monitor downlink signal quality of a user equipment at least in part on measurement results received from the user equipment, said controller further configurable to compare the downlink signal quality to a threshold value and, if the downlink signal quality is less than the threshold value, to switch operation of the user equipment from a full duplex frequency division duplex mode of operation to a half duplex frequency division duplex mode of operation.

33. The apparatus of claim 32, where the controller and the radio frequency receiver are embodied at a base station, and where said controller is further configurable with a radio frequency transmitter to transmit at least a revised radio resource allocation to the user equipment to cause the user equipment to switch from the full duplex frequency division duplex mode of operation to the half duplex frequency division duplex mode of operation.

34. The apparatus of claim 32, where the downlink operates in accordance with an orthogonal frequency division multiple access technique.

35. The apparatus of claim 32, said controller is configurable to continue to monitor the downlink signal quality, and if the downlink signal quality exceeds the same or a different threshold value, to cause the user equipment to switch from the half duplex frequency division duplex mode of operation to the full duplex frequency division duplex mode of operation.

36. The apparatus of claim 32, embodied at least partially as at least one integrated circuit.

37. The apparatus of claim 32, where said controller is further responsive to receiving a request from the user equipment to switch operation of the user equipment from the full duplex frequency division duplex mode of operation to the half duplex frequency division duplex mode of operation, where the request is received at least partially in response to the user equipment detecting the scheduling uplink and downlink resources such that transmission coincides with reception.

38. The apparatus of claim 32, where switching results in an increase in user equipment receiver sensitivity.
